(19) United States
(12) Patent Application Publication
(10) Pub. No.: US 2006/0104165 A1
(43) Pub. Date: May 18, 2006

(54) Pickup head feeding apparatus

(75) Inventors: Li-Ming Wan, Shenzhen (CN); Chien-Ting Lo, Tu-Chen (TW); Bin-Hai Guo, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Chen City (TW)

(21) Appl. No.: 11/198,104

(22) Filed: Aug. 5, 2005

(30) Foreign Application Priority Data
Nov. 18, 2004 (CN) 200420095588.5

(51) Int. Cl. G11B 7/00

(52) U.S. Cl. 369/44.14

(57) ABSTRACT

An apparatus for feeding a pickup head in a radial direction of a disk includes a guiding device, a driving source, a feeding screw, a connecting base, and an elastic member. The guiding device slidingly engages with the pickup head and defines a moving direction of the pickup head. The driving source applies a driving force to the pickup head. The feeding screw is rotatably supported by the driving source. The connecting base is attached to the pickup head and is engaged with the feeding screw. The elastic member is contained in the connecting base and is composed of a first and a second main plate, each main plate respectively contacting the connecting base.

### BACKGROUND

1. Field of the Invention

The present invention is generally related to a disk drive apparatus for recording and/or reproducing information signals by rotating a disk, and more particularly, is related to a pickup head feeding apparatus suitable for use in this disk drive apparatus.

2. Related Art

Optical disk drive apparatuses have been widely used in audio and video equipment for reading and/or reproducing audio, video, documents, and the like in media such as CD (Compact Disk), DVD (Digital Versatile Disk), etc.

A conventional optical disk reproducing apparatus, which reproduces information from an optical disk, generally includes a spindle motor for rotating an optical disk arranged thereon and an optical pickup head for reading information from a recording layer of the optical disk. The optical pickup head is opposed to a read-out surface of the optical disk and can slide in a radial direction of the optical disk.

To slidingly move the optical pickup head in a radial direction of the optical disk, a pickup head feeding device is necessarily provided in the optical disk reproducing apparatus. A typical pickup head feeding device includes a pair of guide shafts respectively mounted at opposite sides of an opening defined on a bracket of the optical disk reproducing apparatus. The optical pickup head is slidingly supported between the guide shafts. A drive motor mounted on the bracket has a rotary shaft adapted to act as a feeding shaft for moving the optical pickup head toward and away from the spindle motor. The screw shaft is parallel to the guide shafts and has a screw groove on an outer peripheral surface thereof. A connecting base is positioned to engage with the screw groove of the screw shaft. The connecting base includes a fixing end fixed on the optical pickup head, a connecting arm extending from the fixing end, an L-shaped base connected with an end of the connection arm, and a plurality of teeth formed on a side of the L-shaped base. A spring is arranged between the fixing end and the L-shaped base and beneath the connection arm, so as to push the teeth against the screw groove of the screw shaft.

In the above-mentioned pickup head feeding device of the related art, a fluttering phenomenon often occurs when the optical pickup head is sliding, especially when sliding in two reverse or opposite directions for jumping to an objective track. The fluttering phenomenon may reduce the precision of data reproduction which is a matter of priority for selecting a recording and/or reproducing apparatus.

Therefore, a heretofore unaddressed need exists in the industry to address aforementioned deficiencies and inadequacies related to the fluttering phenomenon.

### SUMMARY OF THE INVENTION

One embodiment of the present invention provides an apparatus for feeding a pickup head in a radial direction of a disk. The apparatus generally includes a guiding means, a driving source, a feeding screw, a connecting base, and an elastic means. The guiding means slidingly engages with the pickup head for defining a moving direction of the pickup head. The driving source applies a driving force, and the feeding screw is rotatably supported by the driving source. The connecting base is attached to the pickup head and engaged with the feeding screw. The elastic means is contained in the connecting base and includes a first and a second main plate, respectively, contacting with the connecting base.

### BRIEF DESCRIPTION OF THE DRAWINGS

Many aspects of the invention can be better understood with reference to the following drawings. The components in the drawings are not necessarily to scale, the emphasis instead being placed upon clearly illustrating the principles of the present invention. Moreover, in the drawings, like reference numerals designate corresponding parts throughout the several views.

FIG. 1 is an isometric view of a main body of an optical disk recording and/or reproducing apparatus which utilizes a pickup-head feeding apparatus according to a preferred embodiment of the present invention;

FIG. 2 is a rear isometric view of the main body of FIG. 1;

FIG. 3 is an enlarged, isometric view of an assembly of the optical pickup head and the pickup head feeding apparatus of FIG. 2;

FIG. 4 is an enlarged, isometric view of a transmission means of the pickup head feeding apparatus of FIG. 3;

FIG. 5 is an exploded, isometric view of the transmission means of the pickup head feeding apparatus of FIG. 4; and

FIG. 6 is a cross-sectional view taken along line VI-VI of FIG. 2.

### DETAILED DESCRIPTION OF PREFERRED EMBODIMENT

According to research, a reason causing the fluttering phenomenon in the above-described pickup head feeding device of the related art has been found. In the above-described pickup head feeding device, the engagement between the teeth of the connecting base and the screw shaft mainly depends on the elasticity of the spring. However, there is only one spring disposed between the fixing end and the L-shaped base, and an end of the spring, which contacts the L-shaped base, usually is small and circular in shape. Therefore, the elastic force for pushing teeth can not be even to every tooth. Due to such an uneven force distribution, unstable engagements between some teeth and the screw groove can easily exist, thereby promoting the fluttering phenomenon.

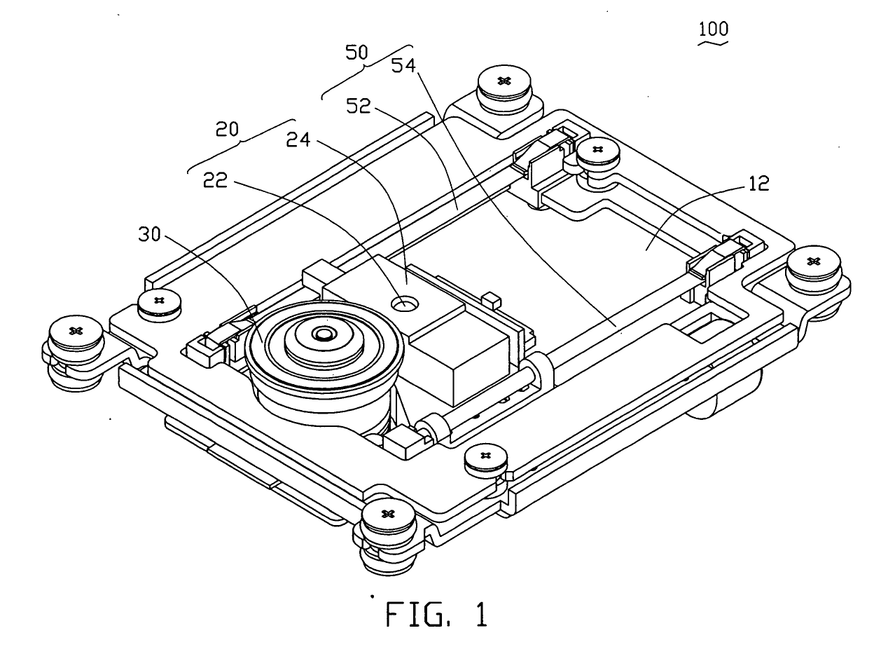

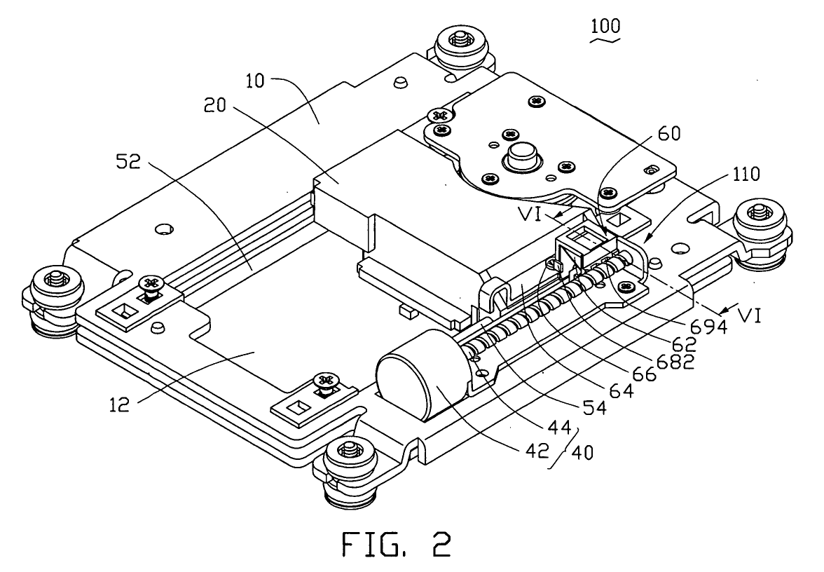

Hereinafter, an embodiment of a pickup-head feeding apparatus 110 (FIGS. 1 and 2) according to the present invention will be described in detail with reference to the accompanying drawings.

FIGS. 1 and 2 show a main body 100 of an optical disk recording and/or reproducing apparatus (not shown in full) which utilizes a pickup head feeding apparatus (generally indicated at 110) according to an embodiment of the present invention. The main body 100 includes a chassis 10 with a longitudinal opening 12. A spindle motor 30 is installed on the chassis 10 at a side of the longitudinal opening 12 for rotating an optical disk (not shown) arranged thereon. An optical pickup head 20 is installed in the longitudinal opening 12 of the chassis 10 and is movable along a radial direction of the optical disk located on the spindle motor 30 and thus is radially movable relative to spindle motor 30. The optical pickup head 20 includes a pickup base 24 and an optical pickup 22 received in the pickup base 24 for recording data on and/or reading data from a recording surface of the optical disk.

The pickup head feeding apparatus 110 includes a guiding means 50, a driving means 40, and a transmission means 60. The guiding means 50 is for supporting the pickup head 20 and defining a moving direction of the optical pickup head 20. The driving means 40 generates a driving force for moving the optical pickup head 20. The transmission means 60 is attached to the optical pickup head 20 and is engaged with the driving means 40 for transmitting the driving force from the driving system 40 to the optical pickup head 20.

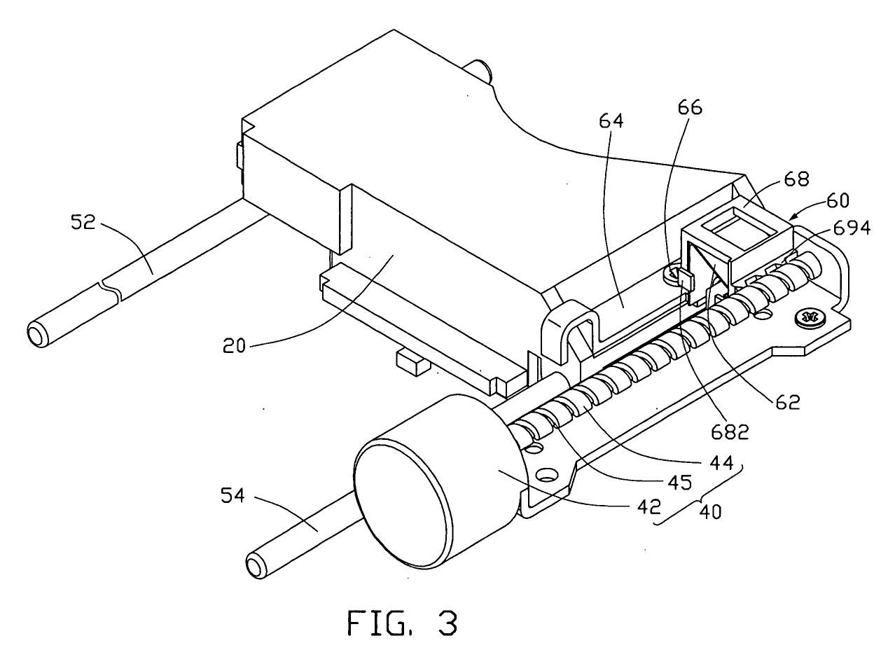

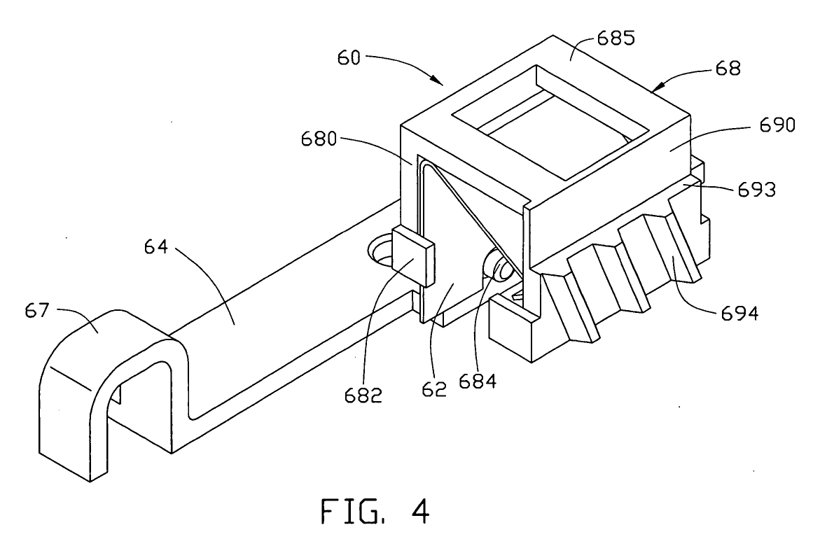

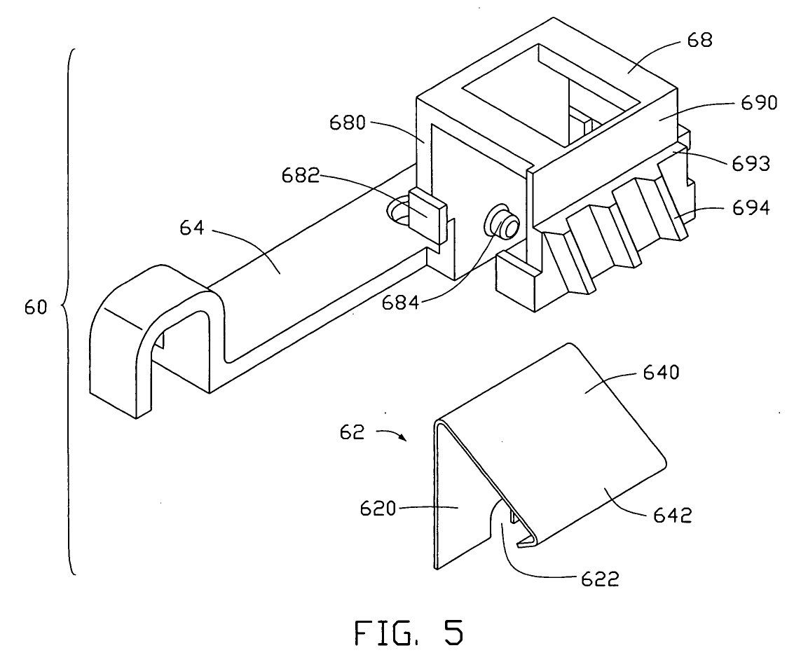

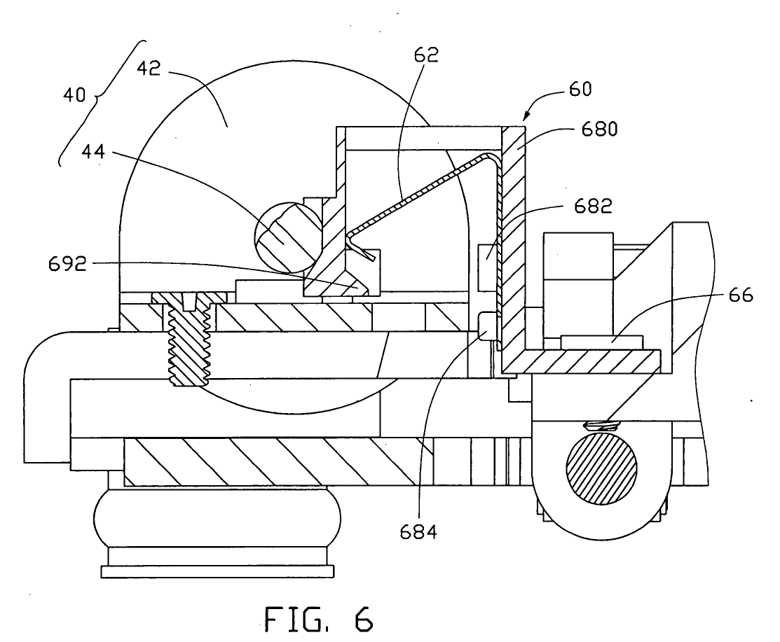

Also referring to FIG. 3 to FIG. 6, the guiding means 50 includes a pair of guide shafts 52 and 54 installed along opposite sides of the longitudinal opening 12 of the chassis 10. The guide shafts 52 and 54 are parallel with each other and slidably engaged with the pickup base 24. The driving means 40 includes a driving motor 42 and a feeding screw 44. The driving motor 42 is fixed on the chassis 10. The feeding screw 44 is a rotary shaft of the driving motor 42 for moving the optical pickup head 20 toward and away from the spindle motor 30. The feeding screw 44 is parallel with the guide shafts 52 and 54 and has a spiral groove 45 defined at the periphery thereof to engage with the transmission means 60.

The transmission means 60 for transmitting the driving force from the driving means 40 to the pickup base 24 includes an integrally formed connecting base 68 and an elastic means 62 contained in the connecting base 68. The connecting base 68 has first and second opposite walls 680 and 690 with a predetermined interval distance between them. The connecting base 68 further includes a connecting portion 685 perpendicularly interconnecting the first and second walls 680 and 690. The first wall 680 has an inner surface (not labeled) facing the second wall 690, and an outer surface (not labeled) spaced away from the second wall 690. Near a lower side of the first wall 680, a locating protrusion 684 protrudes from the inner surface of the first wall 680, and a fixing portion 64 perpendicularly extends from the outer surface of the first wall 680. At least one screw hole (not labeled) is defined in the fixing portion 64, so as to secure the transmission means 60 to the lower portion of the pickup base 24 via a bolt 66. A buffer 67 is formed at a distal end of the fixing portion 64 for reducing vibration of the optical pickup head 20 due to collision. A pair of blocks 682 extends from the fixing portion 64 along two opposite lateral sides of the first wall 680. Each of the pair of blocks 682 is perpendicular to the first wall 680 and the fixing portion 64, respectively.

The second wall 690 of the connecting base 68 also includes an inner surface (not labeled) facing the first wall 680 and an outer surface (not labeled) directed away from the first wall 680. A blocking part 692 extends from the inner side surface of the second wall 690 at a lower side to reduce the distance between the first wall 680 and the second wall 690 there. An engaging portion 693 is formed on the outer surface of the second wall 690. The engaging portion 693 includes a plurality of teeth 694 engaging with the spiral groove 45 of the feeding screw 44. In the present embodiment, three teeth 694 are formed for stable engagement with the feeding screw 44. It is preferable that the teeth 694 are inclined to correspond to the inclination of the spiral groove 45 and spaced apart from each other with a predetermined distance equal to a pitch of the spiral groove 45. Thus, the teeth 694 of the connecting base 68 are engageable with the feeding screw 44.

The elastic means or member 62 allows the teeth 694 to engage with the spiral groove 45. The elastic means 62 also forces the teeth 694 not to separate from the spiral groove 45 of the feeding screw 44. The elastic means 62 is disposed between the first wall 680 and the second wall 690 and may be made of a metal material. The elastic means 62 is about V-shaped and includes a first main plate 620 and a second main plate 640. The first main plate 620 contacts with the first wall 680 of the connecting base 68, and the second main plate 640 interconnects with the first main plate 620. The first main plate 620 is substantially rectangular and may have the same size as the inner surface of the first wall 680. Thus, a stable contact can exist between the first main plate 620 and the inner surface of the first wall 680. A cut 622 is defined at an edge of the first main plate 620, with the protrusion 684 running therethrough. The second main plate 640 is also rectangular and has a hook-shaped pressing portion 642 to push the second wall 690 of the connecting base 68. The pressing portion 642 has the same structure facing or directed toward each tooth 694. In the present embodiment, the pressing portion 642 is a hook extending along a line defined by the arrangement of the teeth 694. In accordance with an alternative embodiment (not shown) of the present invention, the pressing portion 642 can be a hackle having a plurality of teeth opposite to the engaging portion 693 of the connecting base 68.

When moving the optical pickup head 20 along a radial direction of an optical disk, the driving motor 42 is activated to rotate the feeding screw 44 for applying a driving force. The driving force is transmitted to the optical pickup head 20 by the engagement of the feeding screw 44 and the teeth 694 of the connecting base 68. The elastic means 62 applies a sufficient, consistent, and equivalent elastic force to each tooth 694, so that the teeth 694 can well engage with the spiral groove 45 of the feeding screw 44. Therefore, the fluttering phenomenon can be avoided and then, even when the driving motor 42 rotates the feeding screw 44 in two reverse or opposing directions, the teeth 694 of the connecting base 68 can also engage with the feeding screw 44.

It should be emphasized that the above-described embodiment of the present invention is merely one possible example of its implementation and is merely set forth for a clear understanding of the principles of the invention. Many variations and modifications may be made to the above-described embodiment of the invention without departing substantially from the spirit and principles of the invention. All such modifications and variations are intended to be included herein within the scope of this disclosure and the present invention and protected by the following claims.

What is claimed is:

1. Apparatus for feeding a pickup head in a radial direction of a disk, said apparatus comprising:
a guiding means for slidingly engaging with the pickup head and for defining a moving direction of the pickup head;
a driving source configured for applying a driving force for moving the pickup head,
a feeding screw rotatably supported by said driving source,
a connecting base configured for attachment with the pickup head, said connecting base engaging with said feeding screw, and
an elastic means contained in said connecting base comprising a first and second main plate, said first and second main plate each respectively contacting with said connecting base.

2. The apparatus according to the claim 1, wherein said connecting base comprises a first base wall, a second base wall opposite to said first base wall, and a base fixing portion, said base fixing portion being configured to be combined with the pickup head, the elastic means being disposed between said first and second walls.

3. The apparatus according to the claim 2, wherein said first main plate contacts and presses said first base wall, and said second main plate contacts and presses said second base wall.

4. The apparatus according to the claim 3, wherein said connecting base further includes a locating protrusion protruding from said first base wall, said first main plate including a receiving portion configured for engaging said locating protrusion.

5. The apparatus according to the claim 3, wherein said connecting base further comprises a plurality of teeth extending from said second base wall, said elastic means pushing each said tooth to engage said feeding screw with an equivalent elastic force.

6. The apparatus according to the claim 2, wherein said connecting base further comprises a pair of blocks formed at opposite sides of said first base wall.

7. Apparatus for feeding a pickup head in a radial direction of a disk, said apparatus comprising:
a guiding means for slidingly engaging with the pickup head and for defining a moving direction of the pickup head;
a driving means for applying a driving force to the pickup head; and
a transmission means configured for attachment to the pickup head, said transmission means engaging with said driving means, said transmission means thereby being configured to transmit said driving force from said driving means to the pickup head, said transmission means comprising a plurality of teeth and an elastic member, said elastic member being configured for elastically pushing each said tooth against said driving means with an equivalent elastic force.

8. The apparatus according to the claim 7, wherein said elastic member comprises a pressing portion with the same structure facing each said tooth.

9. The apparatus according to the claim 8, wherein said pressing portion extends along an arranged line of said teeth and opposes each said tooth.

10. The apparatus according to the claim 7, wherein said driving means comprises a driving source and a feeding screw rotatedly supported by said driving source.

11. The apparatus according to the claim 10, wherein said feeding screw comprises a spiral groove engaging with said teeth.

12. The apparatus according to the claim 7, wherein said transmission means further includes a base configured for attachment with the pickup head, said base comprising a first wall, a second wall opposite to said first wall, and a fixing portion secured to the pickup head, said elastic means being disposed between said first and second walls.

13. The apparatus according to the claim 12, wherein said elastic member comprises a first main plate contacting said first wall and a second main plate contacting said second wall.

14. The apparatus according to the claim 1, further comprising a pair of blocks arranged next to opposite sides of the first main plate.

15. The apparatus according to the claim 1, further comprising a buffer extending from the fixing portion adapted to reduce vibration of the optical pickup due to collision.
